(19) United States
(12) Patent Application Publication
(10) Pub. No.: US 2025/0266511 A1
(43) Pub. Date: Aug. 21, 2025

(54) BATTERY SYSTEM AND BATTERY PACK

(71) Applicant: Prime Planet Energy & Solutions, Inc., Tokyo (JP)

(72) Inventor: Masato NAKAYAMA, Akashi-shi (JP)

(21) Appl. No.: 19/048,966

(22) Filed: Feb. 10, 2025

(30) Foreign Application Priority Data
Feb. 20, 2024 (JP) 2024-023303

(51) Int. Cl. H01M 10/42; B60L 3/00; G01K 1/14; G01K 3/00; H01M 10/48; H01M 50/204

(52) U.S. Cl. CPC H01M 10/425; B60L 3/0046; G01K 1/14; G01K 3/005; H01M 10/482; H01M 10/486; H01M 50/204; B60L 2240/545; H01M 2010/4278; H01M 2220/20

(57) ABSTRACT

A battery system includes a plurality of battery packs and a main controller. Each of the battery packs includes a pack case, a cell module including a plurality of battery cells disposed in the pack case, a sub-controller disposed in the pack case and electrically connected to the cell module to use the cell module as its power source, and an abnormality detection element that detects an abnormality in the entirety of the pack case. The main controller is communicably connected to each of the sub-controllers in the plurality of battery packs. The abnormality detection element of one of the plurality of battery packs is communicably connected to the sub-controller of another one of the battery packs.

### CROSS REFERENCE TO RELATED APPLICATIONS

The present application claims priority from Japanese Patent Application No. 2024-023303 filed on Feb. 20, 2024, which is incorporated by reference herein in its entirety.

### BACKGROUND

The present invention relates to battery systems and battery packs.

JP 2010-080135 A, for example, discloses a battery system including a plurality of battery blocks connected in series, a battery status detection circuit, and a main control circuit. Each battery block includes a plurality of battery cells connected in series. The battery status detection circuit is connected to each of the battery cells, and includes a circuit that detects the voltage and temperature of the battery cells.

The battery status detection circuit outputs the voltage and temperature of each of the battery cells to the main control circuit. The main control circuit controls the status of each of the battery cells based on the voltage and temperature of each of the battery cells.

### SUMMARY

In the battery system disclosed in JP 2010-080135 A, the battery status detection circuit is electrically connected to the battery block that is to be detected, to use the battery block as the power source. If an abnormality occurs in the battery block and power is not supplied to the battery status detection circuit, it may be possible that the electric power source for the battery status detection circuit is lost. In this case, there may be a risk that the battery status detection circuit does not start properly and is thus unable to detect the status of the battery block.

In accordance with the present disclosure, a battery system includes a plurality of battery packs and a main controller. Each of the battery packs includes a pack case, a cell module including a plurality of battery cells disposed inside the pack case, a sub-controller disposed inside the pack case and electrically connected to the cell module to use the cell module as its power source, and an abnormality detection element detecting an abnormality in an entirety of the pack case. The main controller is communicably connected to the sub-controllers of the plurality of battery packs. The abnormality detection element of one of the plurality of battery packs is communicably connected to the sub-controller of another one of the plurality of battery packs.

The battery system according to the present disclosure allows an abnormality in the entirety of the pack case of one of the battery packs to be detected by the sub-controller of another one of the battery packs through the abnormality detection element of the one of the battery packs, even when an abnormality occurs in the entirety of the pack case of the one of the battery packs and the electric power source for the sub-controller of the one of the battery packs is lost.

In accordance with the present disclosure, a battery pack includes: a pack case; a cell module including a plurality of battery cells disposed in the pack case; a sub-controller disposed in the pack case, and electrically connected to the cell module to use the cell module as its power source; an abnormality detection element detecting an abnormality in an entirety of the pack case; a first connection port connected to the sub-controller; and a second connection port connected to the abnormality detection element.

### BRIEF DESCRIPTION OF THE DRAWINGS

FIG. 1 is a schematic view illustrating a battery system according to a first embodiment.

FIG. 2 is a flowchart illustrating an abnormality detection method.

FIG. 3 is a block diagram illustrating the configuration of a main controller.

FIG. 4 is a schematic view illustrating a battery system according to a second embodiment.

### DETAILED DESCRIPTION

Hereinbelow, embodiments of the technology according to the present disclosure will be described with reference to the drawings. It should be noted, however, that the embodiments disclosed herein are, of course, not intended to limit the invention. The drawings are schematic illustrations, and do not necessarily reflect any actual product. The features and components that exhibit the same effects are designated by the same reference symbols as appropriate, and the description thereof will not be repeated as appropriate.

### First Embodiment

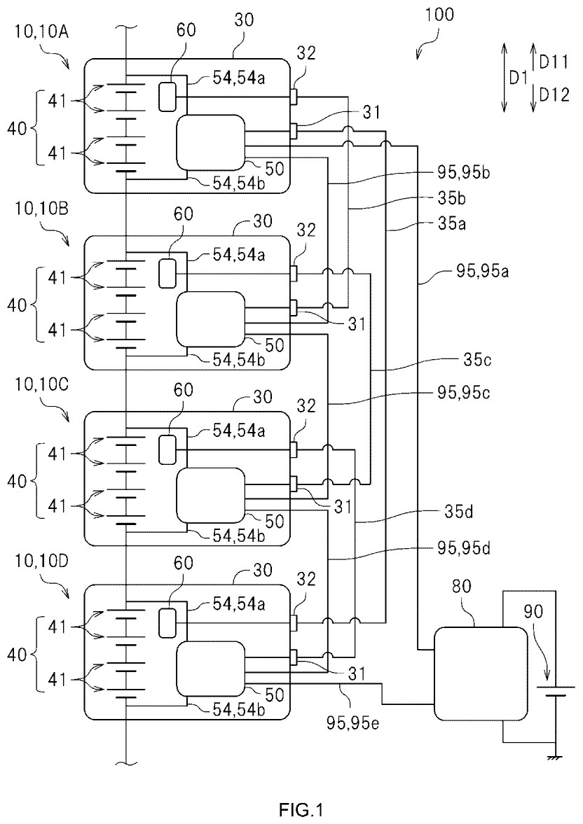

FIG. 1 is a schematic view illustrating a battery system 100 according to a first embodiment. The battery system 100 according to the present embodiment is connected to a load, not shown. The load to be connected to the battery system 100 is not limited to any particular type of load. The load may be, for example, a load in a vehicle, which may include a drive device of the vehicle, such as an electric motor, or an inverter or the like. The battery system 100 is mounted in a vehicle, such as a hybrid electric vehicle and an battery electric vehicle, and is used as the power source to supply electric power to an electric motor for driving the vehicle. The battery system 100 is, however, not limited to those for use in vehicles.

As illustrated in FIG. 1, the battery system 100 includes a plurality of battery packs 10, a main controller 80, and an auxiliary equipment power supply 90. The number of battery packs 10 is not limited to any particular number, but may be 4 herein. The number of battery packs 10 may be 2, or 3, or 5 or more.

In the present embodiment, the plurality of battery packs 10 are arrayed side by side along a predetermined arrangement direction D1. The arrangement direction D1 extends linearly. However, it is also possible that the arrangement direction D1 may extend curvilinearly or may extend partially curvilinearly. Herein, a direction extending from one end (downward end in FIG. 1) toward the other end (upward end in FIG. 1) of the arrangement direction D1 is referred to as a first direction D11. A direction extending from the other end toward the one end of the arrangement direction D1 is referred to as a second direction D12. The first direction D11 is the opposite direction to the second direction D12.

In the following description, the plurality of battery packs 10 are referred to as battery packs 10A, 10B, 10C, and 10D, respectively in that order, along the direction extending from the other end toward the one end (i.e., the second direction D12 herein). That is, the battery pack 10A is disposed closest to an end of the battery pack array in the first direction D11. The battery pack 10D is disposed closest to an end of the battery pack array in the second direction D12. The battery pack 10B is disposed between the battery pack 10A and the battery pack 10C. The battery pack 10C is disposed between the battery pack 10B and the battery pack 10D. Herein, the battery packs 10A, 10B, 10C, and 10D have the same configuration. Hereinafter, in the description common to the battery packs 10A, 10B, 10C, and 10D, the battery pack may be referred to as a battery pack 10.

As illustrated in FIG. 1, each one of the battery packs 10 includes a pack case 30, a cell module 40, a sub-controller 50, and an abnormality detection element 60. The pack case 30 is a case that contains space in the inside thereof. The pack case 30 is formed of a metal, for example. However, the material that forms the pack case 30 is not limited to any particular material.

The cell module 40 includes a plurality of battery cells 41. The cell module 40 is disposed inside the pack case 30. In other words, the plurality of battery cells 41 are disposed inside the pack case 30. The battery cells 41 are ones that are capable of being charged and discharged. Each of the battery cells 41 may be, for example, a secondary battery in which repeated charging and discharging are possible by means of migration of charge carriers through an electrolyte between a pair of electrodes (for example, positive electrode and negative electrode). Each of the battery cells 41 may be a lithium-ion secondary battery, a nickel-metal hydride battery, or the like, for example. In the present embodiment, the plurality of battery cells 41 are connected in series. Herein, the plurality of battery cells 41 are connected in series via a bus bar, not shown. However, it is also possible that the plurality of battery cells 41 may be connected in parallel. The number of battery cells 41 in each one cell module 40 is not limited to any particular number and may be a predetermined number. The number of battery cells 41 in the cell module 40 in each of the battery packs 10 may be the same or different.

The sub-controller 50 is provided for each battery pack 10, in other words, for each pack case 30, to output detected information on an abnormality in the entirety of the pack case 30 to the main controller 80. The sub-controller 50 is composed of an ASIC (Application Specific Integrated Circuit), for example. However, the sub-controller 50 may be composed of a microcomputer, for example. The sub-controller 50 may include a communication interface, a central processing unit (CPU) that executes control program instructions, a read only memory (ROM) that stores programs executed by the CPU, a random access memory (RAM) used as a working area for deploying the programs, and a storage device, such as a memory, that stores the foregoing programs and various data. Note that the sub-controller 50 may be composed of a single device (for example, a single CPU) or may be configured to execute control operations by a plurality of devices in cooperation with each other.

The sub-controller 50 is housed in the pack case 30. In the present embodiment, the sub-controller 50 uses the cell module 40 (in other words, a plurality of battery cells 41) as the power source. The sub-controller 50 is electrically connected to the cell module 40. In the present embodiment, the sub-controller 50 is electrically connected to the cell module 40 via a power wire 54. The power wire 54 includes a first power wire 54a that is electrically connected to the positive electrode side of the cell module 40 and a second power wire 54b that is electrically connected to the negative electrode side of the cell module 40.

The abnormality detection element 60 detects an abnormality in the entirety of the pack case 30. Herein, the phrase “abnormality in the entirety of pack case 30” refers to an abnormality of a component, such as a battery cell 41 of the cell module 40, that is housed in the pack case 30. The abnormality of the cell module 40 (for example, a battery cell 41) may be, for example, a high temperature abnormality that occurs due to a high temperature of the battery cell 41. In the following description, the phrase “abnormality in the entirety of pack case 30” may also be referred to as “abnormality inside pack case 30”.

The abnormality detection element 60 is disposed (in other words, housed) inside the pack case 30. However, the abnormality detection element 60 may also be disposed external to the pack case 30 when it is able to detect an abnormality in the entirety of the pack case 30. In the present embodiment, the abnormality detection element 60 detects an abnormality inside the pack case 30 in which it is housed. Note that the abnormality detection element 60 is not limited to any particular type. In the present embodiment, the abnormality detection element 60 is composed of a temperature sensor. The abnormality detection element 60 detects the temperature inside the pack case 30. In the present embodiment, for example, when an abnormality occurs in the entirety of the pack case 30, the temperature inside the pack case 30 may become higher. Accordingly, the abnormality detection element 60 detects that an abnormality is occurring in the entirety of the pack case 30 when the temperature inside the pack case 30 has become higher. Note that although not shown in the drawings, the abnormality detection element 60 may be electrically connected to the auxiliary equipment power supply 90, for example, to use the auxiliary equipment power supply 90 as its power source.

In the present embodiment, as illustrated in FIG. 1, the plurality of battery packs 10 contained in the battery system 100 (battery packs 10A, 10B, 10C, and 10D herein) are arrayed side by side along the arrangement directions D1 and are connected in series. In other words, the cell modules 40 included in the plurality of battery packs 10 are connected in series. However, it is also possible that the plurality of cell modules 40 may be connected in parallel.

In the present embodiment, each of the battery packs 10 includes a first connection port 31 and a second connection port 32. The first connection port 31 and the second connection port 32 are provided on the pack case 30. The first connection port 31 is connected to the sub-controller 50 in the pack case 30. The sub-controller 50 is communicably connected to an external component (herein, another abnormality detection element 60) outside the pack case 30 that houses the sub-controller 50 via the first connection port 31. The second connection port 32 is connected to the abnormality detection element 60 inside the pack case 30. The abnormality detection element 60 is communicably connected to an external component (herein, another sub-controller 50) outside the pack case 30 that houses the abnormality detection element 60 via the second connection port 32.

In the present embodiment, the abnormality detection element 60 of one of the battery packs 10 is communicably connected to the sub-controller 50 of another one of the battery packs 10. Herein, for example, the sub-controller 50 of the battery pack 10A is communicably connected to the abnormality detection element 60 of one of the other battery packs 10B, 10C, and 10D. For example, the sub-controller 50 of the battery pack 10B is communicably connected to the abnormality detection element 60 of one of the other battery packs 10A, 10C, and 10D. Herein, the sub-controller 50 is not housed in the same pack case 30 that houses the abnormality detection element 60 communicably connected to the sub-controller 50, but is housed in another pack case 30.

In the present embodiment, as illustrated in FIG. 1, the sub-controller 50 of each of the battery packs 10 is communicably connected to one of the battery packs 10 that are adjacent thereto along the arrangement directions D1. More specifically, each of the sub-controllers 50 of the battery packs 10B, 10C, and 10D, which are other than the battery pack 10A that is disposed closest to an end of the battery pack array in the first direction D11 among the plurality of battery packs 10, is communicably connected to the abnormality detection element 60 of one of the battery packs 10 that are adjacent thereto along the arrangement directions D1. For example, the sub-controller 50 of the battery pack 10B is communicably connected to the abnormality detection element 60 of one of the battery packs 10A and 10C that are adjacent thereto along the arrangement directions D1. For example, the sub-controller 50 of the battery pack 10C is communicably connected to the abnormality detection element 60 of one of the battery packs 10B and 10D that are adjacent thereto along the arrangement directions D1.

More specifically, the sub-controller 50 of the battery pack 10B is connected to the abnormality detection element 60 of the battery pack 10A that is adjacent thereto in the first direction D11. The sub-controller 50 of the battery pack 10C is connected to the abnormality detection element 60 of the battery pack 10B that is adjacent thereto in the first direction D11. The sub-controller 50 of the battery pack 10D is connected to the abnormality detection element 60 of the battery pack 10C that is adjacent thereto in the first direction D11. In the present embodiment, the sub-controller 50 of the battery pack 10A, which is disposed closest to an end of the battery pack array in the first direction D11 among the plurality of battery packs 10, is connected to the abnormality detection element 60 of the battery pack 10D, which is disposed closest to an end of the battery pack array in the second direction D12.

In the present embodiment, the first connection port 31 of the battery pack 10A and the second connection port 32 of the battery pack 10D are connected to each other by a connecting wire 35a. The sub-controller 50 of the battery pack 10A is connected to the abnormality detection element 60 of the battery pack 10D via the connecting wire 35a. The first connection port 31 of the battery pack 10B and the second connection port 32 of the battery pack 10A are connected to each other by a connecting wire 35b. The sub-controller 50 of the battery pack 10B is connected to the abnormality detection element 60 of the battery pack 10A via the connecting wire 35b. The first connection port 31 of the battery pack 10C and the second connection port 32 of the battery pack 10B are connected to each other by a connecting wire 35c. The sub-controller 50 of the battery pack 10C is connected to the abnormality detection element 60 of the battery pack 10B via the connecting wire 35c. The first connection port 31 of the battery pack 10D and the second connection port 32 of the battery pack 10C are connected to each other by a connecting wire 35d. The sub-controller 50 of the battery pack 10D is connected to the abnormality detection element 60 of the battery pack 10C via the connecting wire 35d.

The main controller 80, like the sub-controller 50, may be composed of, for example, an ASIC, but may also be composed of a microcomputer. The main controller 80, like the sub-controller 50, may include a communication interface, a central processing unit, a ROM, a RAM, a storage device, and the like. The sub-controller 80 may be composed of a single device (for example, a single CPU) or may be configured to execute control operations by a plurality of devices in cooperation with each other. The main controller 80 is provided external to the pack case 30.

In the present embodiment, the main controller 80 does not use the cell modules 40 of the battery packs 10 as the power source, but uses the auxiliary equipment power supply 90 as the power source. The main controller 80 is electrically connected to the auxiliary equipment power supply 90. The type of the auxiliary equipment power supply 90 may be, but is not particularly limited to, a storage battery (a lead-acid battery herein), for example.

In the present embodiment, the main controller 80 is communicably connected to each of the sub-controllers 50 respectively included in the plurality of battery packs 10. In the present embodiment, the main controller 80 acquires detection information on an abnormality in the entirety of the pack case 30 from the sub-controller 50 during when it executes an abnormality detection method of detecting whether or not an abnormality is occurring in the entirety of the pack case 30. Based on the detection information, the main controller 80 is able to detect that an abnormality is occurring inside the pack case 30 of one of the plurality of battery packs 10.

In the present embodiment, as illustrated in FIG. 1, the main controller 80 and the plurality of sub-controllers 50 are communicably connected to each other to form a ring topology. The connection topology of the main controller 80 and the plurality of sub-controllers 50 is a ring topology. In other words, the main controller 80 and the plurality of sub-controllers 50 are connected so as to be able to communicate with each other in a loop fashion.

As illustrated in FIG. 1, for example, the main controller 80 and the plurality of sub-controllers 50 are communicably connected via communication wires 95. In other words, two communication wires 95 are connected to each of the main controller 80 and the plurality of sub-controllers 50. The plurality of sub-controllers 50 are able to output information in two directions to the main controller 80. In the present embodiment, the main controller 80 is communicably connected to the sub-controller 50 of the battery pack 10A via a communication wire 95a. The sub-controller 50 of the battery pack 10A is communicably connected to the sub-controller 50 of the battery pack 10B via a communication wire 95b. The sub-controller 50 of the battery pack 10B is communicably connected to the sub-controller 50 of the battery pack 10C via a communication wire 95c. The sub-controller 50 of the battery pack 10C is communicably connected to the sub-controller 50 of the battery pack 10D via a communication wire 95d. Then, the sub-controller 50 of the battery pack 10D is communicably connected to the main controller 80 via a communication wire 95e.

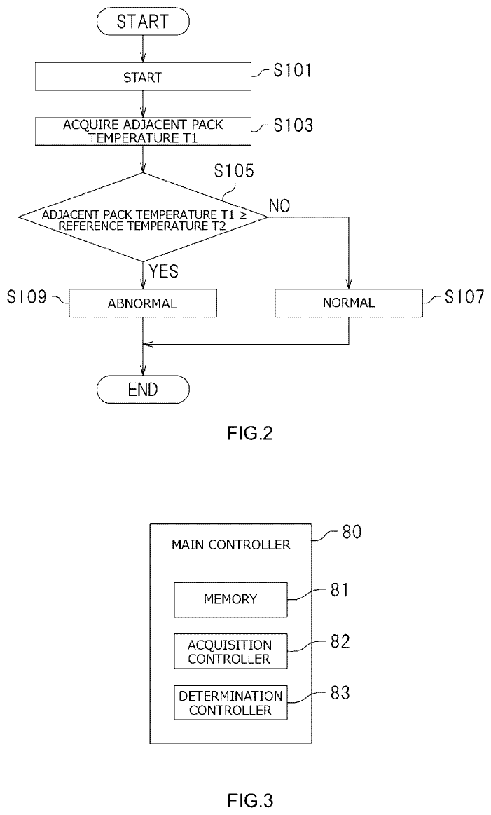

Hereinabove, an exemplary configuration of the battery system 100 according to the present embodiment has been described. Next, an abnormality detection method as to whether or not an abnormality has occurred in the entirety of the pack case 30 of one of the plurality of battery packs 10 included in the battery system 100 will be described with reference to the flowchart of FIG. 2.

FIG. 3 is a block diagram illustrating the configuration of the main controller 80. In the present embodiment, in order to sequentially execute the flowchart shown in FIG. 2, the main controller 80 includes a memory 81, an acquisition controller 82, and a determination controller 83. The memory 81, the acquisition controller 82, and the determination controller 83 may be implemented by a single processor or a plurality of processors, or may be implemented by circuit.

In the present embodiment, first, at step S101 of FIG. 2, the battery system 100 is started. Herein, the main controller 80 executes a predetermined start-up process. This start-up process starts up the sub-controller 50 and the abnormality detection element 60 of each of the battery packs 10. Herein, the start-up process by the main controller 80 causes the sub-controller 50 of each of the battery packs 10 to be started by the power that is supplied from the cell module 40 (a plurality of battery cells 41 herein) that is electrically connected thereto. The abnormality detection element 60 of each of the battery packs 10 is started by the power supplied from the auxiliary equipment power supply 90 that is electrically connected thereto. Herein, the starting of the abnormality detection element 60 means a state in which it can detect the temperature inside the pack case 30. The starting of the sub-controller 50 means a state in which it can acquire the temperature detected by the abnormality detection element 60 to output the temperature to the main controller 80.

Next, at step S103 shown in FIG. 2, the acquisition controller 82 of the main controller 80 shown in FIG. 3 acquires an adjacent pack temperature T1. Herein, the acquisition controller 82 acquires the adjacent pack temperature T1 from each of the sub-controllers 50. Herein, the term “adjacent pack temperature T1” means the temperature inside the pack case 30 that houses the abnormality detection element 60 that is communicably connected to the sub-controller 50. For example, the adjacent pack temperature T1 that is acquired from the sub-controller 50 of the battery pack 10B means the temperature inside the pack case 30 of the battery pack 10A that is detected by the abnormality detection element 60 of the battery pack 10A. For example, the adjacent pack temperature T1 that is acquired from the sub-controller 50 of the battery pack 10A means the temperature inside the pack case 30 of the battery pack 10D that is detected by the abnormality detection element 60 of the battery pack 10D.

In the present embodiment, upon receiving an instruction from the main controller 80, each of the sub-controllers 50 acquires the adjacent pack temperature T1 and outputs it to the main controller 80. For example, when the acquisition controller 82 of the main controller 80 acquires the adjacent pack temperature T1 from each of the sub-controllers 50, the main controller 80 first transmits an acquisition signal to each of the sub-controller 50. The sub-controller 50 that has received the acquisition signal from the main controller 80 acquires, from the abnormality detection element 60 to which it is connected, the temperature inside the pack case 30 that houses the abnormality detection element 60. Herein, the sub-controller 50 transmits a temperature acquisition signal to the abnormality detection element 60 to which it is connected. The abnormality detection element 60 that has received the temperature acquisition signal from the sub-controller 50 to which it is connected detects (i.e., measures herein) the temperature inside the pack case 30 in which it is housed.

Thereafter, the abnormality detection element 60 transmits the detected temperature inside the pack case 30 to the sub-controller 50 to which it is connected. The sub-controller 50 acquires the temperature inside the pack case 30 that has been detected and transmitted by the abnormality detection element 60 to which it is connected as an adjacent pack temperature T1. Then, the sub-controller 50 transmits the acquired adjacent pack temperature T1 to the main controller 80. The acquisition controller 82 of the main controller 80 acquires the adjacent pack temperature T1 that has been transmitted from the sub-controller 50. In the above-described manner, the acquisition controller 82 is able to acquire the adjacent pack temperature T1 from each of the sub-controllers 50.

Next, at step S105 shown in FIG. 2, the determination controller 83 of the main controller 80 shown in FIG. 3 determines whether or not an abnormality is occurring inside the pack case 30. Herein, the determination controller 83 determines whether or not the adjacent pack temperature T1 is higher than or equal to a predetermined reference temperature T2. For example, when an abnormality occurs in one of the plurality of cell modules 40 housed in a pack case 30, the temperature inside the pack case 30 rises. When an abnormality occurs inside a pack case 30, for example, the adjacent pack temperature T1 acquired from the sub-controller 50 connected to the abnormality detection element 60 that detects the temperature of the pack case 30 in which the abnormality has occurred, becomes higher. Therefore, the determination controller 83 determines whether or not the adjacent pack temperature T1 is higher than or equal to a predetermined reference temperature T2 at step S105. The reference temperature T2 is stored in advance in the memory 81 (see FIG. 3) of the main controller 80. The reference temperature T2 is set based on the temperature inside a pack case 30 that is expected when an abnormality occurs in the pack case 30.

In the present embodiment, if the determination controller 83 determines that the adjacent pack temperature T1 is lower than the reference temperature T2 at step S105, the process next proceeds to step S107 shown in FIG. 2. At step S107, the main controller 80 determines that the inside of the pack case 30 in which the adjacent pack temperature T1 has been detected is normal. On the other hand, if the determination controller 83 determines that the adjacent pack temperature T1 is higher than or equal to the reference temperature T2 at step S105, the process next proceeds to step S109 shown in FIG. 2. At step S109, the main controller 80 determines that an abnormality is occurring inside the pack case 30 in which the adjacent pack temperature T1 has been detected. For example, if the adjacent pack temperature T1 acquired from the sub-controller 50 of the battery pack 10A is higher than or equal to the reference temperature T2, the main controller 80 determines that an abnormality is occurring inside the pack case 30 of the battery pack 10D. For example, if the adjacent pack temperature T1 acquired from the sub-controller 50 of the battery pack 10C is higher than or equal to the reference temperature T2, the main controller 80 determines that an abnormality is occurring inside the pack case 30 of the battery pack 10B.

In the above-described manner, the processes are executed in the sequence shown in FIG. 2 to perform the abnormality detection method. In the present embodiment, the main controller 80 transmits an acquisition signal to each of the sub-controllers 50 every predetermined detection time has elapsed. The main controller 80 executes step S103 through step S109 shown in FIG. 2 sequentially at the time when it transmits an acquisition signal to each of the sub-controllers 50.

Note that the main controller 80 determines, for each of the battery packs 10, whether or not an abnormality is occurring inside the pack case 30. Then, if the main controller 80 determines that an abnormality is occurring inside the pack case 30 of one of the plurality of battery packs 10, the main controller 80 determines that an abnormality is occurring in the battery system 100. If the main controller 80 determines that an abnormality is occurring in the battery system 100, the main controller 80 executes a predetermined abnormality process. This abnormality process may be, but is not particularly limited to, a process of stopping the battery system 100, for example, or may be a process of sending a notification to a higher-level controller (for example, an overall controller of the vehicle in which the battery system 100 is incorporated). It should be noted that if all the battery packs 10 are normal, it means that the battery system 100 is normal, so the main controller 80 does not perform any special control operation.

In the present embodiment, as illustrated in FIG. 1, the abnormality detection element 60 of one of the plurality of battery packs 10 is communicably connected to the sub-controller 50 of another one of the battery packs 10, as described previously. A possible cause of an abnormality that occurs in the entirety of a pack case 30 may be, for example, an abnormality of a plurality of cell modules 40 housed in the pack case 30 (for example, a high temperature abnormality that occurs because the cell module 40 (at least one of the plurality of battery cells 41) reaches a high temperature).

Here, it is assumed that an abnormality has occurred in the cell module 40 of the battery pack 10B as illustrated in FIG. 1. In this case, the inside of the pack case 30 of the battery pack 10B shows a high temperature, so the abnormality detection element 60 of the battery pack 10B detects an abnormality inside the pack case 30.

For example, if an abnormality has occurred in the cell module 40 of the battery pack 10B, it is possible that power may not be supplied to the sub-controller 50 to which power is supplied from the cell module 40 in which the abnormality has occurred. If power is not supplied, the sub-controller 50 does not start up properly. In the present embodiment, however, the abnormality detection element 60 of the battery pack 10B is communicably connected to the sub-controller 50 of another one, the battery pack 10C. Here, no abnormality is occurring inside the pack case 30 of the battery pack 10C, so the sub-controller 50 of the battery pack 10C is supplied with power and is started up properly. Thus, an abnormality inside the pack case 30 of the battery pack 10B can be detected by the sub-controller 50 of the battery pack 10C through the abnormality detection element 60 of the battery pack 10B.

In the present embodiment, as illustrated in FIG. 1, the connection topology of the main controller 80 and the plurality of sub-controllers 50 is a ring topology. The information on the adjacent pack temperature T1 is output from the sub-controllers 50 to the main controller 80 through the communication wires 95. As described previously, if an abnormality occurs in the cell module 40 of the battery pack 10B and the sub-controller 50 of the battery pack 10B is thus unusable, the communication wires 95b and 95c that are connected to the sub-controller 50 of the battery pack 10B cannot be used. For this reason, in this case, the sub-controller 50 of the battery pack 10C, for example, outputs the information on the adjacent pack temperature T1 to the main controller 80 through the communication wires 95d and 95e. The sub-controller 50 of the battery pack 10A, for example, outputs the information on the adjacent pack temperature T1 to the main controller 80 through the communication wire 95a.

As described above, in the present embodiment, the battery system 100 includes a plurality of battery packs 10 and a main controller 80, as illustrated in FIG. 1. Each of the battery packs 10 includes a pack case 30, a cell module 40 including a plurality of battery cells 41 disposed inside the pack case 30, a sub-controller 50 disposed inside the pack case 30 and electrically connected to the cell module 40 to use the cell module 40 as its power source, and an abnormality detection element 60 that detects an abnormality in the entirety of the pack case 30. The main controller 80 is communicably connected to each of the sub-controllers 50 in the plurality of battery packs 10. The abnormality detection element 60 of one of the plurality of battery packs 10 is communicably connected to the sub-controller 50 of another one of the battery packs 10. For example, the abnormality detection element 60 of one battery pack 10A is communicably connected to the sub-controller 50 of another battery pack 10B. Thus, even when an abnormality occurs in the entirety of the pack case 30 of one battery pack 10A and the electric power source for the sub-controller 50 of the one battery pack 10A is lost, an abnormality in the entirety of the pack case 30 of the one battery pack 10A can be detected by the sub-controller 50 of another battery pack 10B through the abnormality detection element 60 of the one battery pack 10A.

In the present embodiment, each of the battery packs 10 includes a first connection port 31 connected to a sub-controller 50 and a second connection port 32 connected to an abnormality detection element 60. For example, the second connection port 32 of the one battery pack 10A is connected to the first connection port 31 of another battery pack 10B by a connecting wire 35b. This allows the abnormality detection element 60 of one battery pack 10A and the sub-controller 50 of another battery pack 10B to be communicably connected to each other through the connecting wire 35b.

In the present embodiment, the plurality of battery packs 10 are arranged side by side along a predetermined arrangement direction D1. The sub-controller 50 of each of the battery packs 10 is communicably connected to one of the battery packs 10 that are adjacent thereto along the arrangement direction D1. For example, the sub-controller 50 of the battery pack 10B is communicably connected to the abnormality detection element 60 of the battery pack 10A, which is adjacent thereto along the arrangement direction D1. This makes it possible to shorten the distance between the sub-controller 50 and the abnormality detection element 60 that are to be connected to each other. Accordingly, it is possible to reduce the length of, for example, the connecting wire 35b that connects the sub-controller 50 of the battery pack 10B and the abnormality detection element 60 of the battery pack 10A.

In the present embodiment, a direction extending from one end (downward end in FIG. 1) toward the other end (upward end in FIG. 1) of the arrangement direction D1 is defined as a first direction D11, and a direction extending from the other end toward the one end is defined as a second direction D12. Each of the sub-controllers 50 of the battery packs 10 is connected to the abnormality detection element 60 of one of the battery packs 10 that are adjacent thereto in the first direction D11 of the arrangement direction D1. For example, the sub-controller 50 of the battery pack 10B is connected to the abnormality detection element 60 of the battery pack 10A that is adjacent thereto in the first direction D11. The sub-controller 50 of the battery pack 10A, which is disposed closest to an end of the battery pack array in the first direction D11 among the plurality of battery packs 10, is connected to the abnormality detection element 60 of the battery pack 10D, which is disposed closest to an end of the battery pack array in the second direction D12. This serves to prevent the connecting wires 35a, 35b, 35c, and 35d, which connect the sub-controllers 50 and the abnormality detection elements 60, from being tangled complicatedly.

In the present embodiment, the abnormality detection element 60 is a temperature sensor that detects the temperature inside the pack case 30. Herein, when an abnormality occurs inside the pack case 30, the temperature inside the pack case 30 may become higher. Therefore, as an abnormality detection element 60 detects the temperature inside the pack case 30, the main controller 80 is able to detect that an abnormality is occurring in the entirety of the pack case 30 of the battery pack 10 that corresponds to the abnormality detection element 60.

In the present embodiment, the main controller 80 includes an acquisition controller 82 and a determination controller 83, as illustrated in FIG. 3. The acquisition controller 82 acquires, from a sub-controller 50, the adjacent pack temperature T1 that is detected by the abnormality detection element 60 communicably connected to the sub-controller 50. The determination controller 83 determines whether or not the adjacent pack temperature T1 that is acquired by the acquisition controller 82 is higher than or equal to a predetermined reference temperature T2. The main controller 80 is configured to detect that, if the determination controller 83 determines that the adjacent pack temperature T1 is higher than or equal to the reference temperature T2, an abnormality is occurring in the entirety of the pack case 30 corresponding to the abnormality detection element 60 that has detected the adjacent pack temperature T1. Herein, the reference temperature T2 may be the minimum temperature inside the pack case 30 that is expected when an abnormality occurs inside the pack case 30. This makes it possible to detect an abnormality inside the pack case 30 by a simple control operation of determining whether or not the adjacent pack temperature T1 is higher than or equal to the reference temperature T2.

In the present embodiment, the connection topology of the sub-controllers 50 of the plurality of battery packs 10 and the main controller 80 is a ring topology. Thus, by employing a ring topology for connecting the plurality of sub-controllers 50 and the main controller 80 in this way, additional battery packs 10 may be connected more easily even when the number of the battery packs 10 needs to be increased, resulting in higher scalability. For example, in the example of FIG. 1, when one more battery pack 10 needs to be provided, the one additional battery pack 10 may be disposed between the sub-controller 50 of the battery pack 10D and the communication wire 95e.

Moreover, because the above-mentioned connection topology is a ring topology in the present embodiment, the sub-controllers 50 are able to output information to the main controller 80 in two directions. For example, the sub-controller 50 of the battery pack 10A is able to output information from two directions, the communication wire 95a end and the communication wire 95b end, to the main controller 80. For this reason, even when the electric power source for the sub-controller 50 of the battery pack 10B is lost, the sub-controller 50 of the battery pack 10A is able to output information to the main controller 80 through the communication wire 95a.

### Second Embodiment

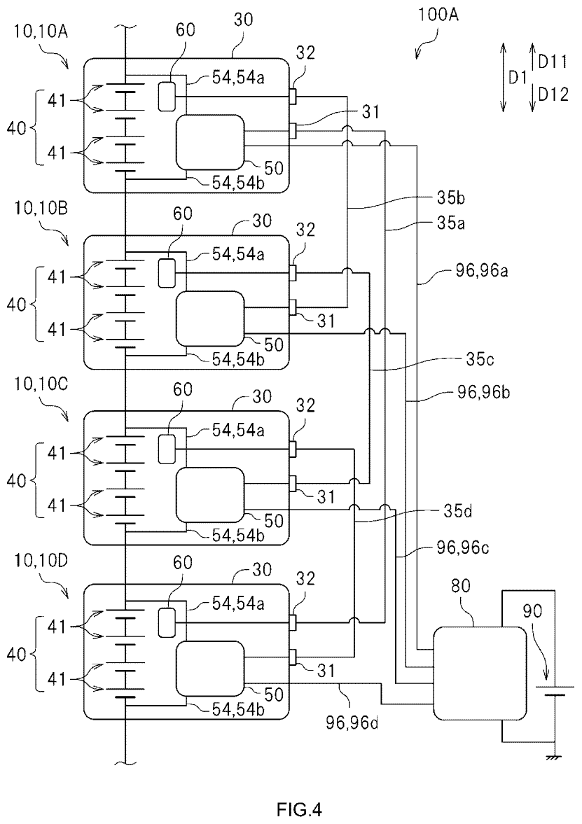

Next, a battery system 100A according to a second embodiment will be described. FIG. 4 is a schematic view illustrating the battery system 100A according to the second embodiment. As illustrated in FIG. 4, in the present embodiment, the battery system 100A includes a plurality of battery packs 10 (battery packs 10A, 10B, 10C, and 10D herein), a main controller 80, and an auxiliary equipment power supply 90. Except for the connection topology of the respective sub-controllers 50 in the plurality of battery packs 10 and the main controller 80, the configuration of the battery system 100A is identical to that of the battery system 100 according to the first embodiment, and therefore, the description of the configuration of the battery system 100A will be omitted as appropriate.

In the present embodiment, the connection topology of the sub-controllers 50 in the plurality of battery packs 10 (battery packs 10A, 10B, 10C, and 10D herein) and the main controller 80 is a star topology. That is, the plurality of sub-controllers 50 are communicably connected to the main controller 80 independently.

As illustrated in FIG. 4, the plurality of sub-controllers 50 are communicably connected to the main controller 80 via communication wires 96. Herein, the sub-controller 50 of the battery pack 10A is communicably connected to the main controller 80 via a communication wire 96a. The sub-controller 50 of the battery pack 10B is communicably connected to the main controller 80 via a communication wire 96b. The sub-controller 50 of the battery pack 10C is communicably connected to the main controller 80 via a communication wire 96c. The sub-controller 50 of the battery pack 10D is communicably connected to the main controller 80 via a communication wire 96d. Note that although one communication wire 96 connects each one of the sub-controllers 50 and the main controller 80 to each other in the present embodiment, it is also possible to use a plurality of communication wires 96 to connect them.

Thus, when the connection topology of the respective sub-controllers 50 in the plurality of battery packs 10 and the main controller 80 is a star topology, the sub-controllers 50 are likewise able to output information to the main controller 80 even if the electric power source for another sub-controller 50 is lost. Therefore, it is possible to obtain the same advantageous effects as those obtained by the first embodiment.

In the embodiments described above, the abnormality detection element 60 is a temperature sensor that detects the temperature inside the pack case 30. However, the abnormality detection element 60 is not limited to a temperature sensor. The abnormality detection element 60 may be a thermal fuse that is housed in the pack case 30 and that blows out when the temperature inside the pack case 30 increases (for example, when the temperature reaches higher than or equal to a predetermined reference temperature). In this case, the sub-controller 50 communicably connected to the abnormality detection element 60 may detect an abnormality in the entirety of the pack case 30 that houses the abnormality detection element 60 because of blowing out of the thermal fuse, which is an example of the abnormality detection element 60.

Various embodiments of the invention have been described hereinabove according to the present disclosure. Unless specifically stated otherwise, the embodiments described herein do not limit the scope of the present invention. It should be noted that various other modifications and alterations may be possible in the embodiments of the invention disclosed herein. In addition, the features, structures, or steps described herein may be omitted as appropriate, or may be combined in any suitable combinations, unless specifically stated otherwise.

As has been described above, the present description contains the disclosure as set forth in the following items.

### Item 1:

A battery system including:
a plurality of battery packs; and
a main controller, wherein:
each of the battery packs includes:
   a pack case;
   a cell module including a plurality of battery cells disposed in the pack case;
   a sub-controller disposed in the pack case and electrically connected to the cell module to use the cell module as its power source; and
   an abnormality detection element detecting an abnormality in an entirety of the pack case;
the main controller is communicably connected to the sub-controllers of the plurality of battery packs; and
the abnormality detection element of one of the plurality of battery packs is communicably connected to the sub-controller of another one of the plurality of battery packs.

### Item 2:

The battery system according to item 1, wherein:
the plurality of battery packs are arrayed side by side along a predetermined arrangement direction; and
each of the sub-controllers of the battery packs is communicably connected to the abnormality detection element of one of the battery packs that are adjacent thereto along the arrangement direction.

### Item 3:

The battery system according to item 2, wherein:
when a direction extending from one end toward another end of the arrangement direction is defined as a first direction and a direction extending from the other end toward the one end is defined as a second direction;
each of the sub-controllers of the battery packs is connected to the abnormality detection element of one of the battery packs that is adjacent thereto in the first direction; and
the sub-controller of one of the battery packs that is disposed closest to an end of the battery pack array in the first direction among the plurality of battery packs is connected to the abnormality detection element of one of the battery packs that is disposed closest to an end of the battery pack array in the second direction.

### Item 4:

The battery system according to any one of items 1 through 3, wherein the abnormality detection element is a temperature sensor detecting a temperature inside the pack case.

### Item 5:

The battery system according to item 4, wherein:
the main controller includes:
   an acquisition controller acquiring, from the sub-controller, an adjacent pack temperature that is detected by the abnormality detection element communicably connected to the sub-controller; and
   a determination controller determining whether or not the adjacent pack temperature acquired by the acquisition controller is higher than or equal to a predetermined reference temperature; and
the main controller is configured to detect that, if the determination controller determines that the adjacent pack temperature is higher than or equal to the reference temperature, an abnormality is occurring in the entirety of the pack case that corresponds to the abnormality detection element that has detected the adjacent pack temperature.

### Item 6:

The battery system according to any one of items 1 through 5, wherein the respective sub-controllers in the plurality of battery packs and the main controller are connected in a ring topology.

### Item 7:

The battery system according to any one of items 1 through 5, wherein the respective sub-controllers in the plurality of battery packs and the main controller are connected in a star topology.

### Item 8:

A battery pack including:
a pack case;
a cell module including a plurality of battery cells disposed in the pack case;
a sub-controller disposed in the pack case, and electrically connected to the cell module to use the cell module as its power source;
an abnormality detection element detecting an abnormality in an entirety of the pack case;
a first connection port connected to the sub-controller; and
a second connection port connected to the abnormality detection element.

What is claimed is:

1. A battery system comprising:
a plurality of battery packs; and
a main controller, wherein:
each of the battery packs includes:
a pack case;
a cell module including a plurality of battery cells disposed in the pack case;
a sub-controller disposed in the pack case and electrically connected to the cell module to use the cell module as its power source; and
an abnormality detection element detecting an abnormality in an entirety of the pack case;
the main controller is communicably connected to the sub-controllers of the plurality of battery packs; and
the abnormality detection element of one of the plurality of battery packs is communicably connected to the sub-controller of another one of the plurality of battery packs.

2. The battery system according to claim 1, wherein:
the plurality of battery packs are arrayed side by side along a predetermined arrangement direction; and
each of the sub-controllers of the battery packs is communicably connected to the abnormality detection element of one of the battery packs that are adjacent thereto along the arrangement direction.

3. The battery system according to claim 2, wherein:
when a direction extending from one end toward another end of the arrangement direction is defined as a first direction and a direction extending from the other end toward the one end is defined as a second direction;
each of the sub-controllers of the battery packs is connected to the abnormality detection element of one of the battery packs that is adjacent thereto in the first direction; and
the sub-controller of one of the battery packs that is disposed closest to an end of the battery pack array in the first direction among the plurality of battery packs is connected to the abnormality detection element of one of the battery packs that is disposed closest to an end of the battery pack array in the second direction.

4. The battery system according to claim 1, wherein the abnormality detection element is a temperature sensor detecting a temperature inside the pack case.

5. The battery system according to claim 4, wherein:
the main controller includes:
an acquisition controller acquiring, from the sub-controller, an adjacent pack temperature that is detected by the abnormality detection element communicably connected to the sub-controller; and
a determination controller determining whether or not the adjacent pack temperature acquired by the acquisition controller is higher than or equal to a predetermined reference temperature; and
the main controller is configured to detect that, if the determination controller determines that the adjacent pack temperature is higher than or equal to the reference temperature, an abnormality is occurring in the entirety of the pack case that corresponds to the abnormality detection element that has detected the adjacent pack temperature.

6. The battery system according to claim 1, wherein the respective sub-controllers in the plurality of battery packs and the main controller are connected in a ring topology.

7. The battery system according to claim 1, wherein the respective sub-controllers in the plurality of battery packs and the main controller are connected in a star topology.

8. A battery pack comprising:
a pack case;
a cell module including a plurality of battery cells disposed in the pack case;
a sub-controller disposed in the pack case, and electrically connected to the cell module to use the cell module as its power source;
an abnormality detection element detecting an abnormality in an entirety of the pack case;
a first connection port connected to the sub-controller; and
a second connection port connected to the abnormality detection element.
